(19) United States
(12) Patent Application Publication
(10) Pub. No.: US 2007/0092124 A1
(43) Pub. Date: Apr. 26, 2007

(54) System for and method of displaying subtraction image and computer program for the system

(75) Inventor: Yoshiyuki Moriya, Kanagawa-ken (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation

(21) Appl. No.: 11/581,450

(22) Filed: Oct. 17, 2006

(30) Foreign Application Priority Data
Oct. 17, 2005 (JP) 301414/2005

(51) Int. Cl. G06K 9/00

(52) U.S. Cl. 382/128

(57) ABSTRACT

In a subtraction image displaying system, object areas extracted from the two medical images obtained by taking a part including an object area to be diagnosed of a subject are located, and a subtraction image of the object area generated on the basis of the difference between the object areas in both the images is stored. Either one of the two medical images is stored, and said one stored medical image is displayed with an image of the object area thereof being replaced with the subtraction image of the object area.

### BACKGROUND OF THE INVENTION

1. Field of the Invention

This invention relates to a subtraction image displaying system, a subtraction image displaying method and a computer program thereof for medically locating images in superposition or subtraction of images.

2. Description of the Related Art

There has been put into practice to extract and diagnose a specific structure or a diseased part in a radiation image by subtracting two radiation images taken under different conditions one from the other by the use of a radiation image subtraction method. As the subtraction method, there has been known a time subtraction where a change with time of a diseased part is observed by obtaining a differential image between two images of a subject taken at different times. When the subtraction is carried out, it is possible to observe only a changed part by extracting and locating a structure to be diagnosed and obtaining a subtraction image.

In order to accurately grasp the change, it is necessary to accurately extract and locate structure to be diagnosed in an image with respect to the other image. Accordingly, there has been proposed, for instance, in Japanese Unexamined Patent Publication No. 6(1994)-175245, a method of subtraction where a range of structure to be diagnosed is obtained from an image of a subject on the basis of a histogram, the subtraction is carried out on the image in the range to obtain corresponding points of the structure on the basis of difference obtained through the subtraction and the subtraction image is generated so that the corresponding points conform to each other.

However, display of the subtraction image which is obtained by subtraction of the located structure will give rise to the following problem. When the locating of images is not performed well and a shift appears in the differential image, the part of the shift is emphasized in white or black, which obstructs reading of the shadow. When the locating of images is performed very well, the whole image is represented in gray and only a changed part appears, it cannot be recognized where the structural parts such as organs are in the image and a relative position of the changed part with respect to the structural parts cannot be recognized, which makes difficult the diagnosis.

### SUMMARY OF THE INVENTION

In view of the foregoing observations and description, the primary object of the present invention is to provide a subtraction image displaying system, a subtraction image displaying method and a computer program thereof which can display the subtraction image so that where the position of the part changed in the located subtraction image is in the whole image of a subject can be recognized while preventing the positional shift.

According to the present invention, there is provided a subtraction image displaying system comprising

a subtraction image storage means which locates the object areas extracted from the two medical images obtained by taking a part including an object area to be diagnosed of a subject, and stores a subtraction image of the object area generated on the basis of the difference between the object areas in both the images,

a medical image storage means which stores either one of the two medical images, and

a subtraction image display means which displays one medical image stored in the medical image storage means with an image of the object area thereof being replaced with the subtraction image of the object area.

The subtraction image displaying system may comprise a medical image storage means which stores a pair of medical images obtained by taking apart including an object area to be diagnosed of a subject,

an object area extracting means which extracts the object area from the pair of medical images,

a locater means which locates the object area extracted from one medical image with respect to the object area extracted from the other medical image,

an object area subtraction image generating means which generates an object area subtraction image corresponding to the difference between the located object areas, and

a subtraction image display means which displays one of the pair of medical images with an image of the object area thereof being replaced with the object area subtraction image.

According to the present invent-on, there is provided a subtraction image displaying method comprising the steps of

storing a pair of medical images obtained by taking a part including an object area to be diagnosed of a subject,

extracting the object areas from the pair of medical images,

locating the object areas extracted from one medical image with respect to the object area extracted from the other medical image,

generating an object area subtraction image corresponding to the difference between the located object areas, and

a subtraction image display means which displays one of the pair of medical images with an image of the object area thereof being replaced with the object area subtraction image.

According to the present invention, there is provided a computer program for causing a computer to function as a subtraction image displaying system comprising

an object area extracting means which extracts the object area from a pair of medical images obtained by taking a part including an object area to be diagnosed of a subject,

a locater means which locates the object area extracted from one medical image with respect to the object area extracted from the other medical image,

an object area subtraction image generating means which generates an object area subtraction image corresponding to the difference between the located object area images, and

a subtraction image display means which displays one of the pair of medical images with an image of the object area thereof being replaced with the object area subtraction image.

The computer program may be recorded in a computer readable recording medium. A skilled artisan would know that the computer readable medium is not limited to any specific type of storage devices and includes any kind of device, including but not limited to CDs, floppy disks, RAMs, ROMs, hard disks, magnetic tapes and internet downloads, in which computer instructions can be stored and/or transmitted. Transmission of the computer code through a network or through wireless transmission means is also within the scope of this invention. Additionally, computer code/instructions include, but are not limited to, source, object and executable code and can be in any language including higher level languages, assembly language and machine language.

“Medical images” means, for instance, tomographic images taken by tomography systems such as a CT (computed tomography), or an MRI (magnetic resonance imaging) or simple x-ray images taken by a CR (computed radiography).

“Image storage means” is a memory or a system for recording/storing image data, and may either be a memory which temporarily storing image data during processing or display, and a filing device.

The “object area” may be not only the whole area of the specific structural component to be diagnosed such as an organ but may be a part of such a structural component. Otherwise, the “object area” may be an area including a plurality of structural components.

The “locator means” may locate the image of the object area extracted from one medical image with respect to the image of the object area extracted from the other medical image so that the contour of the object area extracted from one medical image conforms to the object area extracted from the other medical image.

Further, the “locator means” may obtain curvatures on a plurality of points on the contours of the pair of medical images and locate the image of the object area extracted from one medical image with respect to the image of the object area extracted from the other medical image so that the points on the contours of the pair of medical images corresponding to each other approximate each other in curvature.

In accordance with the present invention, since object areas on a pair of medical images are located, an object subtraction image corresponding to the difference between the located object area images is generated and the original image is displayed with the object area thereon replaced with the object subtraction image, the relative position of where the subtraction image has changed on the subtraction image with respect to the other structural components can be easily grasped.

By locating the object areas on a pair of medical images so that the contour of the object area extracted from one medical image conforms to the object area extracted from the other medical image, an accurate locating of the object areas is feasible even if the shape and the position of the organ are shifted from one medical image to the other due to difference in position of the subject.

Further, by locating the object areas on a pair of medical images so that the curvature on points of the object area extracted from one medical image conforms to the object area extracted from the other medical image, the organ extracted from one medical image can be conformed to the organ extracted from the other medical image in the whole shape without extracting feature points from the organ images.

### BRIEF DESCRIPTION OF THE DRAWINGS

FIG. 1 is a view showing in brief a subtraction image displaying system in accordance with an embodiment of the present invention,

FIGS. 2 to 4 are views showing the flow of the processing in the subtraction image displaying system,

FIG. 5 is a view showing examples of the medical images the difference between which is taken,

FIGS. 6A and 6B are views for illustrating extraction of the object area,

FIGS. 7A and 7B are views for illustrating conformation of the contours of the object area,

FIG. 8 is a view showing an example of the object area subtraction image displayed on the tomographic image, and

FIG. 9 is a view showing in brief a subtraction image displaying system in accordance with another embodiment of the present invention.

### DESCRIPTION OF THE PREFERRED EMBODIMENTS

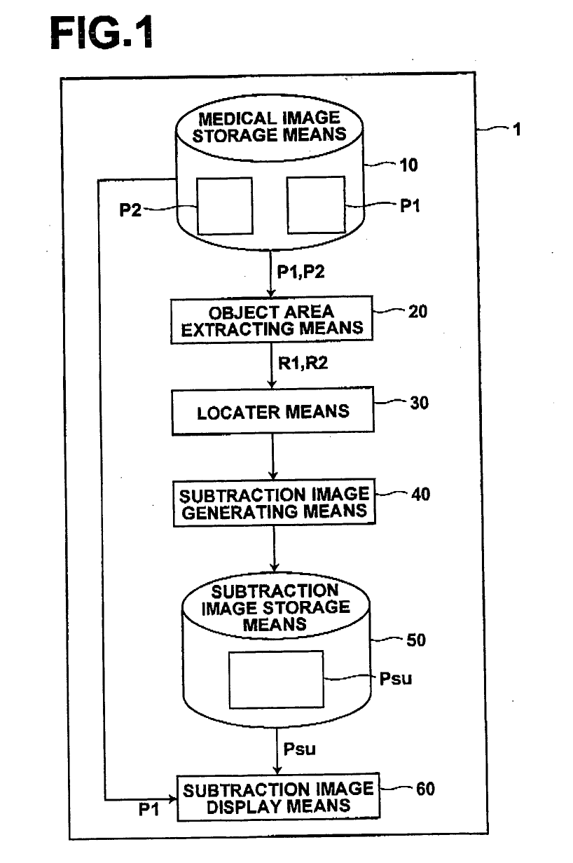

Embodiments of the present invention will be described with reference to the drawings, hereinbelow. FIG. 1 is a view showing in brief a subtraction image displaying system in accordance with an embodiment of the present invention.

As shown in FIG. 1, the subtraction image displaying system 1 of this embodiment comprises a medical image storage means 10 which stores a pair of medical images P1 and P2 obtained by taking a part including an object area to be diagnosed of a subject, an object area extracting means 20 which extracts the object area from the pair of medical images P1 and P2, a locater means 30 which locates the object area extracted from one medical image P1 with respect to the object area extracted from the other medical image P2, an object area subtraction image generating means 40 which generates an object area subtraction image Psu corresponding to the difference between the located object areas, a subtraction image storage means 50 which stores the object area subtraction image Psu and a subtraction image display means 60 which displays either one of the pair of medical images P1 and p2 with an image of the object area thereof being replaced with the object area subtraction image Psu.

Medical images P1 and P2 are tomographic images taken by tomography systems such as a CT, or an MRI or simple x-ray images taken by a CR.

When a subtraction image of tomographic images taken by a tomography system such as a CT is to be generated, the subtraction image is generated by the use of a pair of tomographic images taken at substantially the same part of the subject. In this embodiment, the case where the difference between tomographic images taken by a CT is to be observed will be described, hereinbelow.

A value of each of pixels (referred to as “CT value”, hereinbelow) forming a CT image is set to be expressed on the basis of water (0 in CT value), and the CT value of the air is −1000. The average CT values of the human tissue becomes smaller in the order of (1) bone (2) coagulated blood (3) soft tissue (4) cerebrospinal fluid/blood (5) water (6) fat (7) air. Further, the gray matter of the brain is larger than the white matter of the brain in the CT value, and the heart is larger than the lung in the CT value. In the abdomen, the liver is larger than the other organs. Thus each organ appears on an image with its natural CT value.

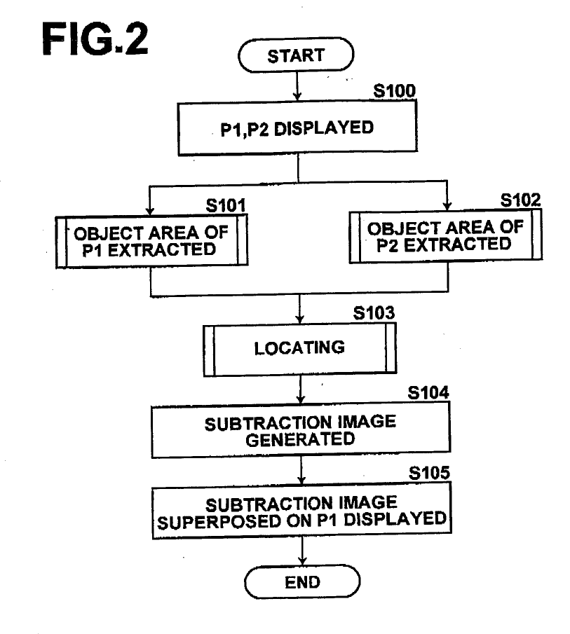

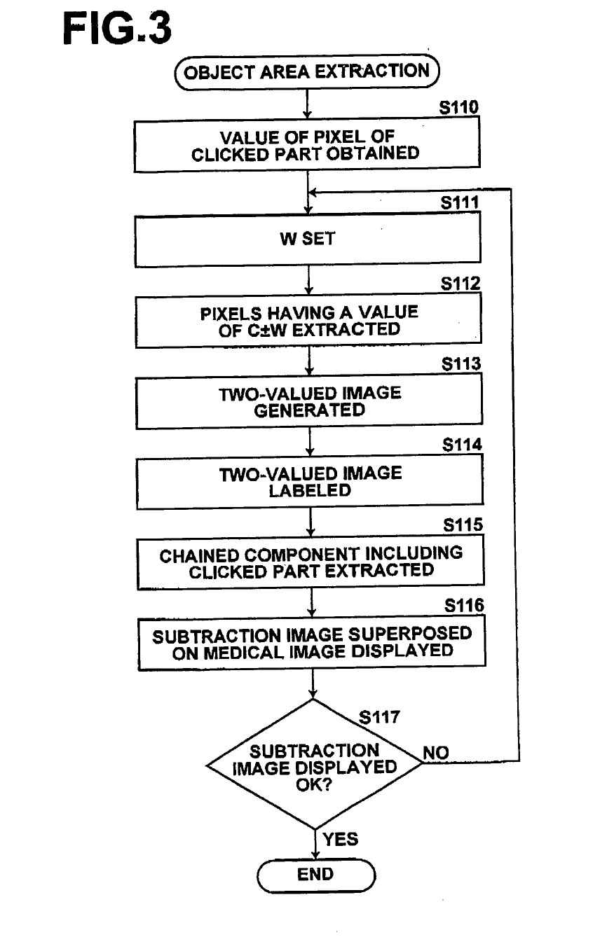

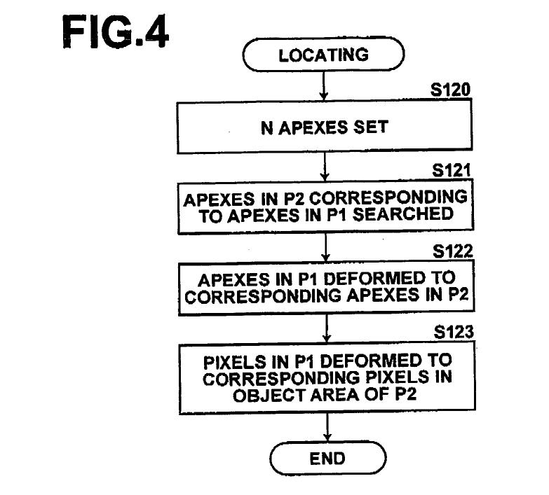

The flow of the processing in the subtraction image displaying system 1 of this embodiment in displaying a subtraction image between images, which are tomographic images taken by a CT in this particular embodiment, will be concretely described with reference to the flow charts in FIGS. 2 to 4.

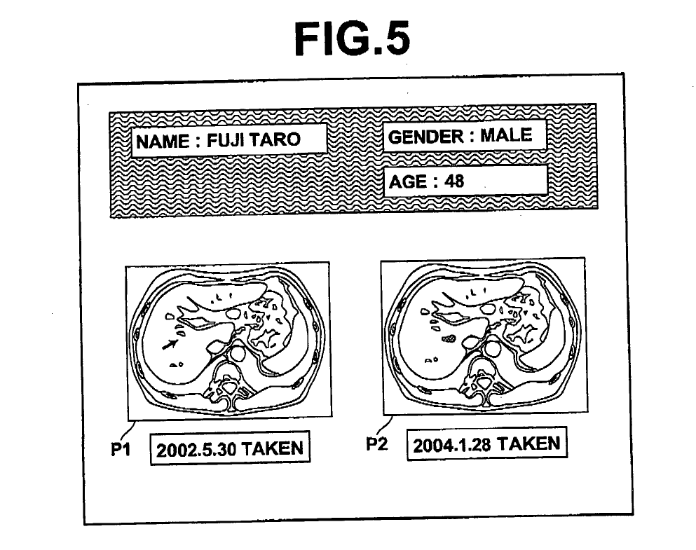

As shown in FIG. 5, tomographic images of the same position of the abdomen are first displayed side by side. (step S100) The operator instructs a point in the organ a subtraction image of which is to be displayed on the tomographic images with a pointing device such as a mouse. (See an arrow in FIG. 5) Since each organ appears on a tomographic image with its natural pixel value, the organ existing in the instructed position has a pixel value close to a value C of the pixel existing in the position pointed by the pointing device (e.g., pointed by the arrow in FIG. 5). For example, the liver which appears on the tomographic image of the abdomen taken by a CT will appear in pixel values different from the surroundings. Accordingly, by picking up the pixels having a pixel value within a predetermined width W from the pixel value of the pixel pointed by the pointing device, only the liver can be extracted.

The object area extracting means 20 extracts the object area R1 from the tomographic image P1 stored in the medical image storage means 10. (step S101) The pixel value C of the pixel in the position clicked on the tomographic image P1 is first obtained. (step S110) The width W of the pixel values are set, for instance, by moving the pointer on the image of the organ to be extracted by operating the mouse wheel and determining the width W on the basis of the pixel values of the pixels in the range over which the pointer has been moved. (step S111) Otherwise, the width W may be determined in advance not to include another organ depending on how the natural pixel values of the organs differ from each other

The object area extracting means 20 extracts the pixels whose pixel values are in the range of C−W to C+W (step S112) and generates a two-valued image where the pixels whose pixel values are in the range of C−W to C+W (step S112) and the pixels whose pixel values are not in the range of C−W to C+W are expressed in two pixel values (step S113).

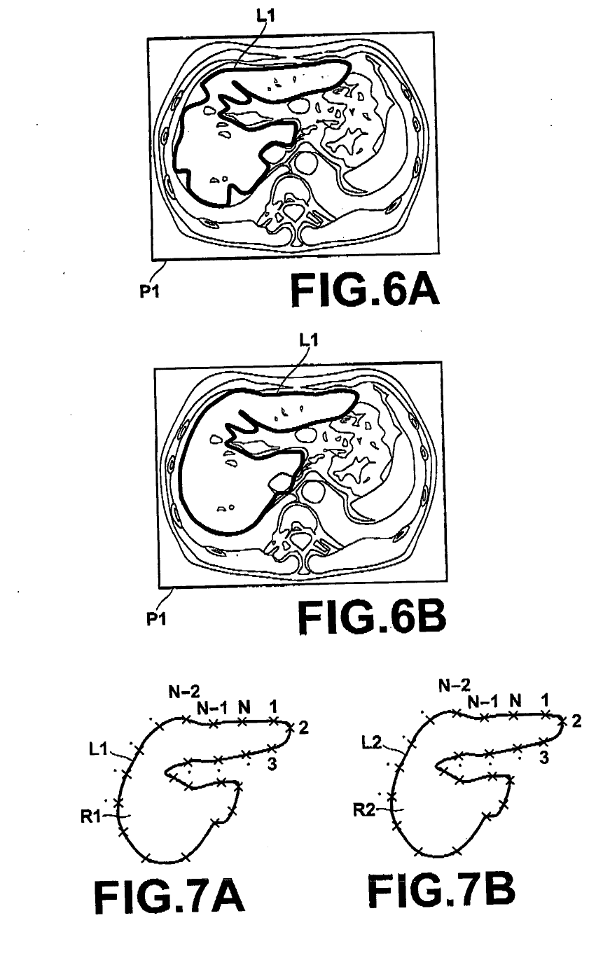

The generated two-valued image undergoes a component chaining processing (labeling processing) (step S114) and is extracted (step S115) as an organ which exists in the position where the area of the chained component including the clicked position has been instructed, that is, as the object area R1. The contour L of the object area R1 extracted by the component chaining processing is obtained and displayed on the subtraction image display means 60 superposed on the tomographic image P1. (step S116) The operator visually confirms whether the borders of the organs which are displayed on the tomographic image P1 conform to the contour line L1 of the extracted object area R1 (the thick line in FIG. 6A or 6B). When the borders of the organs which are displayed on the tomographic image P1 do not conform to the contour L1 of the extracted object area R1 as shown in FIG. 6A, the mouse wheel is operated to pick up the pixel values of the pixels out of the object area R1 so that the width W of the pixel values is changed, and S111 to step S116 are repeated. Each time the width W of the pixel values is changed, the contour L of the object area R1 is repeatedly displayed on the subtraction image display means 60 superposed on the tomographic image P1 and the operator repeatedly changes the width W of the pixel values until the width W of the pixel values becomes optimal where the borders of the organs which are displayed on the tomographic image P1 conform to the contour L1 of the extracted object area R1 as shown in FIG. 6B.

Similarly, the object area is extracted from the tomographic image P2. (step S102) Then the locater means 30 deforms the images in the object area R1 and R2 of the tomographic images P1 and P2 so that the contours L1 and L2 thereof conforms to each other. (step S103)

The locater means 30, as shown in FIGS. 7A and 7B, divides the contours L1 and L2 of the organ extracted from the tomographic images P1 and P2 into apexes of suitable numbers (the same in number in both the tomographic images P1 and P2). Since the order of the apexes 1, 2, 3, . . . N on the contours L1 and L2 is never changed, the corresponding positions are obtained by the use of a suitable evaluation function for the N combinations shifting the correspondence by one. For example, by the use of a function for evaluating the difference in curvature on each apex as the evaluation function, when the difference in the curvature is minimized, the apexes of the combination are determined to be corresponding apexes.

A vector for shifting the apexes on the contour L2 of the tomographic image P2 to the apexes on the contour L1 of the tomographic image P1 so that the contour L2 of the tomographic image P2 approaches the contour L1 of the tomographic image P1 is obtained on the basis of the correspondence between the apexes of the images P1 and P2. When the apex on the contour L1 of the tomographic image P1 is indicated at V1i and the apex on the contour L2 of the tomographic image P2 is indicated at V2i (wherein i is a suffix representing the apexes), the shift vector S (V1i) can be expressed by the following formula (1) (step S122)
S(V1i)=(V2ix−V1ix, V2iy−V1iy) (1)

A shift vector is obtained to shift the pixels in the object area R2 of the tomographic image P2 to the pixels in the object area R1 of the tomographic image P1 to deform the image inward of the contour L2 in response to change thereof so that the shape of the contour L2 of the tomographic image P2 conforms to the shape of the contour L1 of the tomographic image P1 without largely straining the image of the object area R2 surrounded by the contour L2 of the tomographic image P2.

The shift vector for the pixels V(x,y) in the object areas R2 and R1 is obtained by the following formula (2). (step S123)
S(V(x,y))=ΣS(V1i)/D(V,V1i) (2)

wherein ΣD(V, V1i)=1, V(x,y) represents the pixels in the contour of the tomographic image P2 and D(V,V1i) represents the distance between V and V1i.

When the image in the contour of the tomographic image P2 is indicated at A(x,y) and the image B(x,y) after deformation can be expressed by the following formula (3).

B(x,y)=A(x−Sx,y−Sy) wherein Sx and Sy represents the X component and the Y component of the S (V(x, y)) and A(x−Sx, y−Sy) is obtained by interpolation between pixels (e.g., obtained by bilinear interpolation from the pixels of the near points).

Then the object area subtraction image generating means 40 obtains the difference between each pixel of the image in the contour of the tomographic image P1 and each pixel of the tomographic image P2 after deformation to generate an object area subtraction image Psu, and stores it in the subtraction image storage means 50. (step S104)

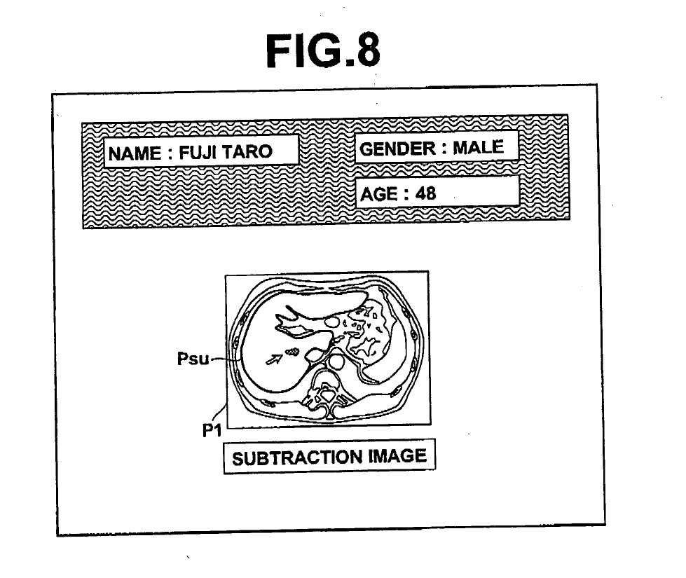

The subtraction image display means 60 displays the tomographic image P1 (the original image) with an image of the object area R1 thereof being replaced with the generated object area subtraction image Psu. (step S105) Only a changed part appears in the object area (white arrow in FIG. 8).

As described above in detail, by displaying the object area subtraction image of the part to be diagnosed superposed on the original image, the relative position with respect to other organs can be accurately grasped.

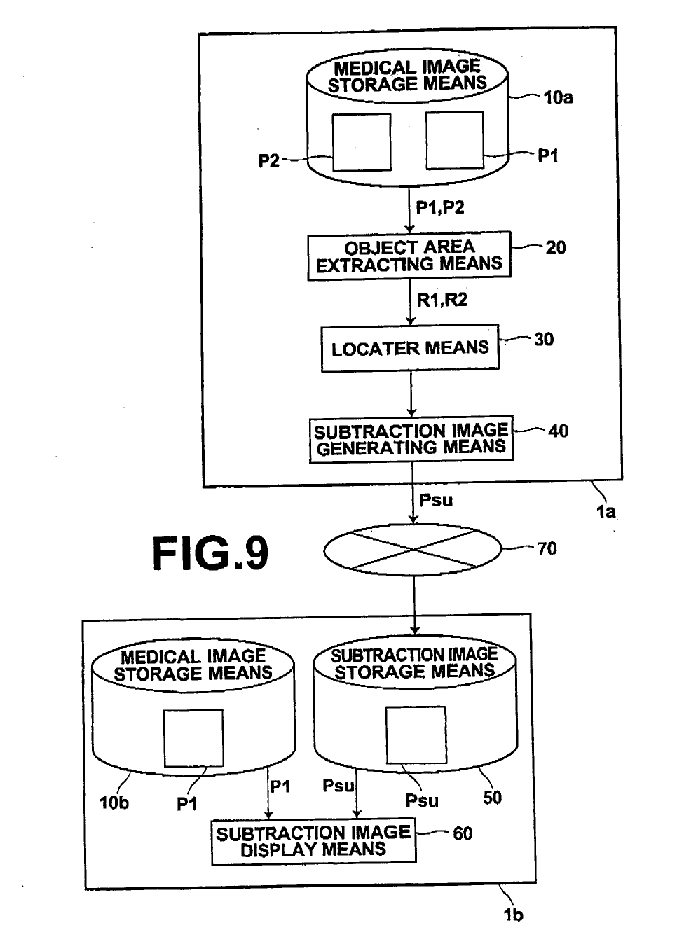

Though, in the above description, generation of the object area subtraction image and display of the original image with an image of the object area thereof being replaced with the object area subtraction image are carried out in a apparatus, a subtraction image generating apparatus 1a which generates the object area subtraction image and a subtraction image displaying apparatus 1b which displays the original image with an image of the object area thereof being replaced with the object area subtraction image may be separately provided as shown in FIG. 9. In-this case, the subtraction image generating apparatus 1a is provided with a medical image storage means 10a which stores a pair of tomographic images P1 and P2, an object area extracting means 20, a locater means 30, an object area subtraction image generating means 40 which generates an object area subtraction image Psu corresponding to the difference between the images of the located object areas, and the subtraction image displaying apparatus 1b is provided with a medical image storage means 10b which stores a tomographic image P1, a subtraction image storage means 50 and a subtraction image display means 60 which displays either one of the pair of medical images P1 and p2 with an image of the object area thereof being replaced with the object area subtraction image Psu. Further, it is possible to transmit the object area subtraction image Psu generated by the subtraction image generating apparatus 1a to the subtraction image displaying apparatus 1b from the subtraction image generating apparatus 1a by way of a network so that the subtraction image displaying apparatus 1b displays a tomographic image P1 with an image of the object area thereof being replaced with the object area subtraction image Psu.

Though, taken by CT in the above description, the medical images may be taken by MRI or CR. Also in this case, the relative position with respect to other organs can be easily grasped by displaying the subtraction image of the part to be diagnosed superposed on the original image.

Further, though, in the above description, the case where an organ forming the object area is extracted from a CT image on the basis of the pixel value has been described, various extractions of an organ such as extraction of the lung from a simple x-ray image of the chest may be employed.

Instead of automatically extracting the object area, the object area may be extracted by manually surrounding an image of a desired organ with the pointing device.

The part of the image showing a part of an organ, a plurality of organs, and an organ or a plurality of organs including its or their surroundings may be extracted not limited to the whole of one organ.

What is claimed is:

1. A subtraction image displaying system comprising
a subtraction image storage means which locates object areas extracted from two medical images obtained by taking a part including an object area to be diagnosed of a subject, and stores a subtraction image of the object area generated on the basis of the difference between the object areas in both the images,
a medical image storage means which stores either one of the two medical images, and
a subtraction image display means which displays one medical image stored in the medical image storage means with an image of the object area thereof being replaced with the subtraction image of the object area.

2. A subtraction image displaying system comprising a medical image storage means which stores a pair of medical images obtained by taking a part including an object area to be diagnosed of a subject,
an object area extracting means which extracts the object area from the pair of medical images,
a locater means which locates the object area extracted from one medical image with respect to the object area extracted from the other medical image,
an object area subtraction image generating means which generates an object area subtraction image corresponding to the difference between the located object areas, and
a subtraction image display means which displays one of the pair of medical images with an image of the object area thereof being replaced with the object area subtraction image.

3. A subtraction image displaying system as defined in claim 2 in which the locator means locates the image of the object area extracted from one medical image with respect to the image of the object area extracted from the other medical image so that the contour of the object area extracted from one medical image conforms to the object area extracted from the other medical image.

4. A subtraction image displaying system as defined in claim 3 in which the locator means obtains curvatures on a plurality of points on the contours of the pair of medical images and locates the image of the object area extracted from one medical image with respect to the image of the object area extracted from the other medical image so that the points on the contours of the pair of medical images corresponding to each other approximate each other in curvature.

5. A subtraction image displaying method comprising the steps of
storing a pair of medical images obtained by taking a part including an object area to be diagnosed of a subject,
extracting the object areas from the pair of medical images,
locating the object area extracted from one medical image with respect to the object area extracted from the other medical image,
generating an object area subtraction image corresponding to the difference between the located object areas, and
a subtraction image display means which displays one of the pair of medical images with an image of the object area thereof being replaced with the object area subtraction image.

6. A computer readable recording medium in which is recorded a computer program for causing a computer to function as a subtraction image displaying system comprising
an object area extracting means which extracts the object area from a pair of medical images obtained by taking a part including an object area to be diagnosed of a subject,
a locater means which locates the object areas extracted from one medical image with respect to the object area extracted from the other medical image,
an object area subtraction image generating means which generates an object area subtraction image corresponding to the difference between the located object area images, and
a subtraction image display means which displays one of the pair of medical images with an image of the object area thereof being replaced with the object area subtraction image.
